(19) United States
(12) Patent Application Publication
(10) Pub. No.: US 2007/0130538 A1
(43) Pub. Date: Jun. 7, 2007

(54) Single page website organization method

(76) Inventor: Fu-Sheng Chiu, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/362,093

(22) Filed: Feb. 27, 2006

(30) Foreign Application Priority Data
Dec. 7, 2005 (TW) 094143198

(51) Int. Cl. G06F 17/00

(52) U.S. Cl. 715/792; 715/517

(57) ABSTRACT

Single page website organization method featuring multiple functions in a single page, previewing of multimedia, and the use of scrolling controls to fit multiple products into a smaller area over a period of time instead of spreading them over a large space. Control methods include a scrolling still image list as well as more complex application-specific controls such as a stadium layout control showing camera angles and fields of view. The interface produced by the design method may be tailored to a wide variety of businesses and applications including sporting events, interviewing, and product sales and marketing.

### BACKGROUND OF THE INVENTION

1. Field of the Invention

The present invention relates to website interface design. More specifically, the present invention discloses a single page website organization method to reduce confusion and simplify interaction.

2. Description of the Prior Art

Traditionally, users have navigated through websites by using links to open new pages. As the next page opens, the page from which the user opened it disappears from view. Browsers typically store a “history” of visited pages so that the user can return to a previously-visited page. Also, a given web page often contains more information than can fit in the available space, and so the user must scroll up and down to view more of the information.

However, this results in users becoming lost in a site. Whether through poor design, deliberate obfuscation, or unnecessary complexity, users have to navigate back and forth through myriad pages, for example, going from a shopping cart to an item page, back to the shopping cart, then to another item page, back to the shopping cart, to a checkout screen, through shipping, and so forth. Information that the user may need in order to make a decision—current total charges, number of items, shipping weights, item availability—is no longer visible. The user has to go back in the browser's history, and may even lose data depending on the site's history mechanism. All of this takes time, and the potential for user error is high.

In addition, the inconvenience of this interface can result in the user losing interest, forgetting an item, or becoming frustrated. Moreover, if a user wants to navigate to a significantly different section of the site, such as a customer service section, the user may have to follow another tortuous series of links before reaching that section. These issues combine to reduce the amount of time that a site may hold a user's interest and the revenue potential, and thus to lower the value and usefulness of the site.

Therefore there is need for an improved website organization method.

### SUMMARY OF THE INVENTION

To achieve these and other advantages and in order to overcome the disadvantages of the conventional method in accordance with the purpose of the invention as embodied and broadly described herein, the present invention provides a single page website organization method for presenting user information in a plurality of subpanes.

The present invention further provides a method for organizing a website with a single page website interface.

The present invention further provides a single page website interface organization method using a scrolling still image bar, having preview pane and display window, thereby allowing the user to select among a plurality of items to investigate in further detail.

The present invention further provides a single page website interface organization method with a user selectable multiple camera angle control, thereby allowing the user to select among a plurality of views.

The present invention further provides a method for entities to sponsor a camera or cameras, thus providing for an advertising revenue model.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings:

FIG. 1 is an example layout of a product marketing single page website of the present invention;

FIG. 2 is an example layout of a product marketing single page website of the present invention;

FIG. 3 is a detail view of a scrolling still image bar control for a single page website of the present invention;

FIG. 4 is a detail view of a multimedia pane for a single page website of the present invention;

FIG. 5 is an example layout of a sporting event single page website of the present invention;

FIG. 6 is an example layout of a sporting event single page website of the present invention;

FIG. 7 is a detail view of a multiple camera angle control for a single page website of the present invention;

FIG. 8 is an example layout of a sporting event single page website of the present invention;

FIG. 9 is a detail view of a first level of a multilevel multiple camera angle control for a single page website of the present invention;

FIG. 10 is a detail view of a second level of a multilevel multiple camera angle control for a single page website of the present invention;

FIG. 11 is a detail view of a multiple camera angle control for a single page website of the present invention;

FIG. 12 is an example layout of a concert single page website of the present invention;

FIG. 13 is a flowchart illustrating a first embodiment of the website interface organization method of the present invention;

FIG. 14 is a flowchart illustrating a second embodiment of the website interface organization method of the present invention; and

FIG. 15 is a flowchart illustrating a third embodiment of the website interface organization method of the present invention.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

In order to better understand the interactive multimedia production of the present invention, a detailed discussion of the system utilizing the present invention is given.

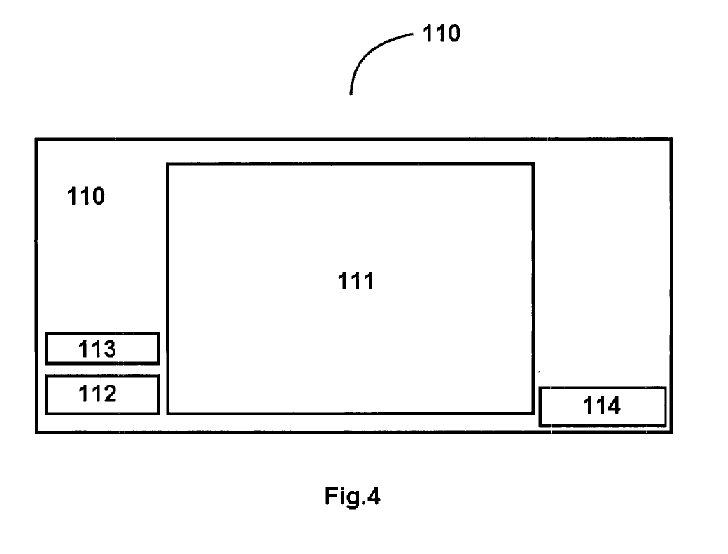

Please refer to FIG. 4, which shows a detail view of a multimedia pane for a single page website of the present invention. The multimedia pane 110 comprises a display area 111, a volume control 112, a pause/play button 113, and an order button 114. It displays a sequence of still images or a video, as chosen by the website designer.

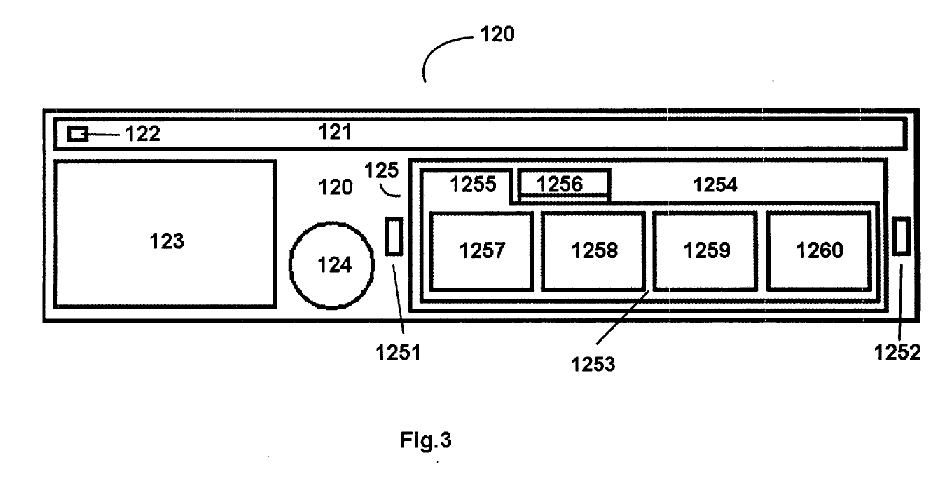

Please refer to FIG. 3, which shows a detail view of a scrolling still image bar control for a single page website of the present invention. The scrolling still image bar control 120 comprises a windowshade bar 121, a toggle button 122, a preview pane 123, an activation button 124, and a tabbed scrollable list 125. The tabbed scrollable list 125 comprises a left button 1251, a right button 1252, an image area 1253, a tab bar 1254 with a plurality of tabs 1255˜1256, and a plurality of images 1257˜1260. The number of images shown at any given time may vary depending on the size and aspect ratio of the images as well as on the width and height of the image area 1253, and of course on the total number of images to be displayed. The tab bar 1254 comprises a plurality of tabs 1255˜1256 which are typically used to select among different groupings of products or items or topics; the number of tabs at any given time may vary depending on the choice of the website designer, the number of products or items or topics, and the width of the image area 1253. Tabs 1255˜1256 are labelled with a brief description of the grouping. Clicking on a tab 1255,1256 typically selects a grouping of products or items or topics, causing a related series of images 1257˜1260 to scroll in the image area 1253. Clicking on the left button 1251 or the right button 1252 causes the images to scroll left or right respectively. In addition, images may automatically scroll in a default direction when the user has not clicked on either the left button 1251 or right button 1252. Clicking on the left button 1251 or right button 1252 may also briefly pause the scrolling behaviour for a configurable amount of time after the button has been clicked, to allow the user to view an item that is presumably of particular interest to have triggered the user action. Clicking on an image 1257,1258,1259,1260 causes a preview to display in the preview pane 123. Clicking on the activation button 124 then causes the full presentation to be shown in the display area 111 of the multimedia pane 110.

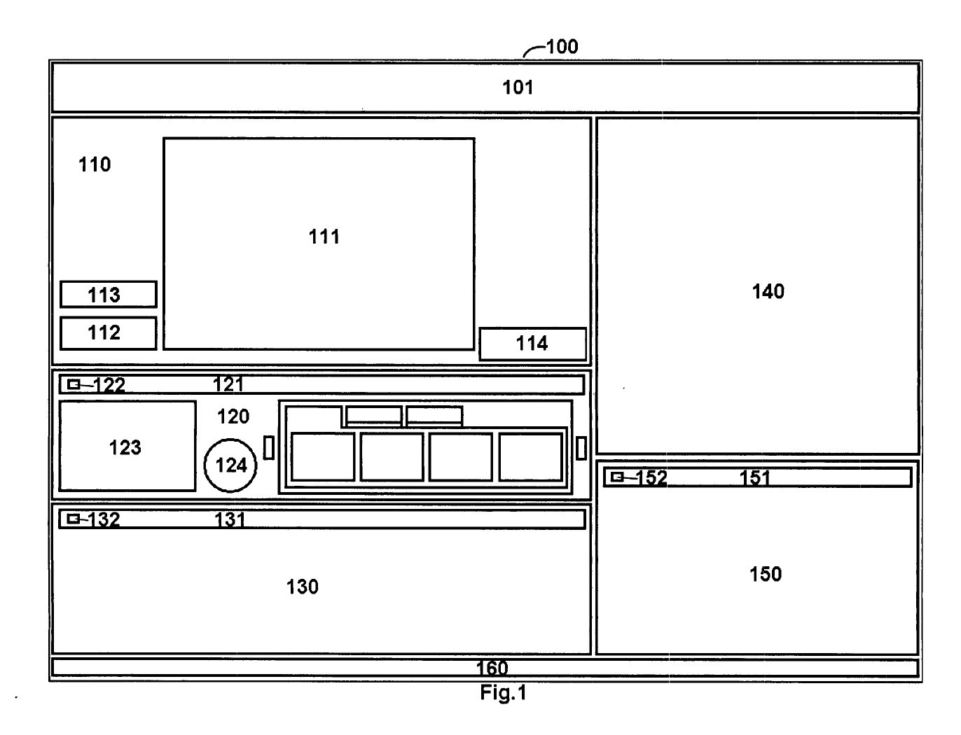

Please refer to FIG. 1, which shows an example layout of a product marketing Single page website of the present invention. The page 100 has a title area 101, a multimedia pane 110, a scrolling still image control 120, an event pane 130, an advertising pane 140, a multifunction pane 150, and a footer 160. This example layout is divided into a left section and a right section; the left section comprises the multimedia pane 110, the scrolling still image control 120, and the event pane 130; and the right section comprises the advertising pane 140 and the multifunction pane 150. The scrolling still image control 120, the event pane 130, and the multifunction pane 150 have windowshade bars 121, 131, and 151 respectively, and toggle buttons 122, 132, and 152 respectively; clicking on a toggle button 122,132 of an open pane causes its respective pane to shrink vertically to the size of its respective windowshade bar, thus freeing up area in the page for the multimedia pane 110 to enlarge, increasing the size of its display area 111; it may retain the aspect ratio of the display area 111 or alter it as appropriate to its content. Conversely, clicking on a toggle button 122,132 of a closed pane causes its respective pane to enlarge vertically to its original layout size, and reducing the available area on the page for the multimedia pane 110. The multimedia pane 110 automatically resizes to take up the maximum available area, thereby providing the user with the largest possible view of the current multimedia presentation in the display area 111, again either maintaining or altering the aspect ratio of the presentation as appropriate to its content. Clicking on the toggle button 152 will likewise cause the multifunction pane 150 to reduce or enlarge its size, depending on whether the multifunction pane 150 is currently open or closed respectively, thereby allowing the advertising pane 140 to, respectively, grow or shrink automatically. The multifunction pane 150 has a wide variety of possible applications, comprising customer surveys, customer service chatroom, application for distributorship, product or service information, product rating surveys, and feature comparisons among multiple products.

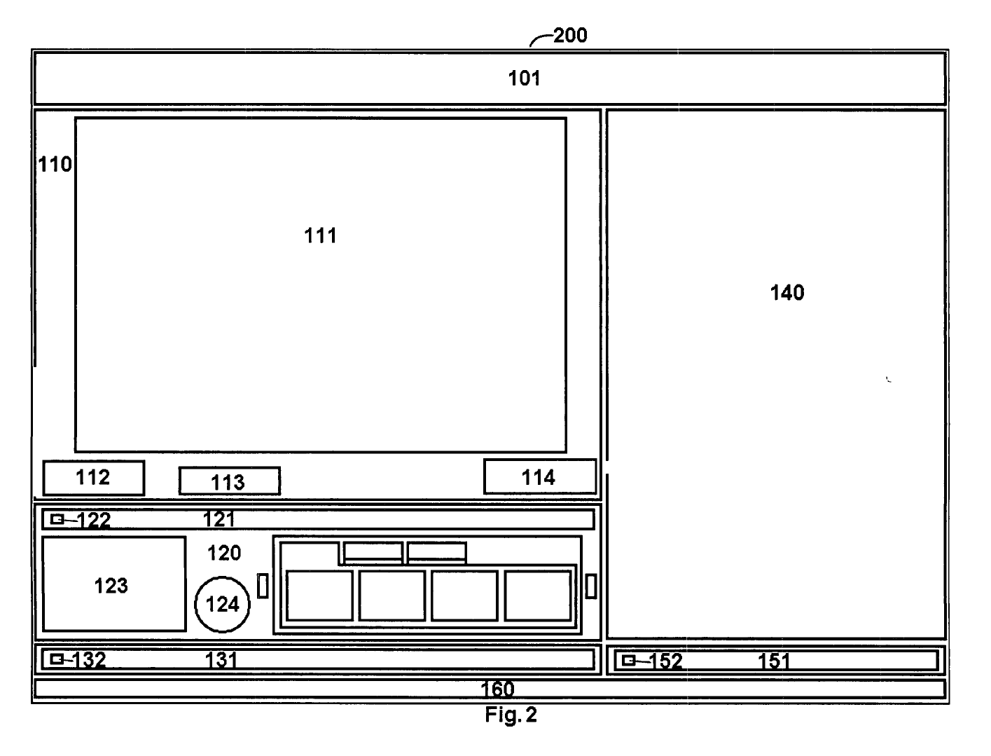

Please refer to FIG. 2, which shows an example layout of a product marketing single page website of the present invention. This layout shows a page 200 with the event panel 130 reduced to the size of its windowshade bar 131 after its toggle button 132 has been clicked, and the multifunction panel 150 likewise reduced to the size of its windowshade bar 151 after its toggle button 152 has been clicked; the multimedia pane 110 and advertising pane 140 have grown correspondingly, with the display area 111 of the multimedia pane 110 likewise having increased in size, and with the volume control 112, pause/play button 113, and order button 114 having been rearranged automatically by a layout manager to accommodate the largest possible display area 111 while retaining the aspect ratio of the display area 111.

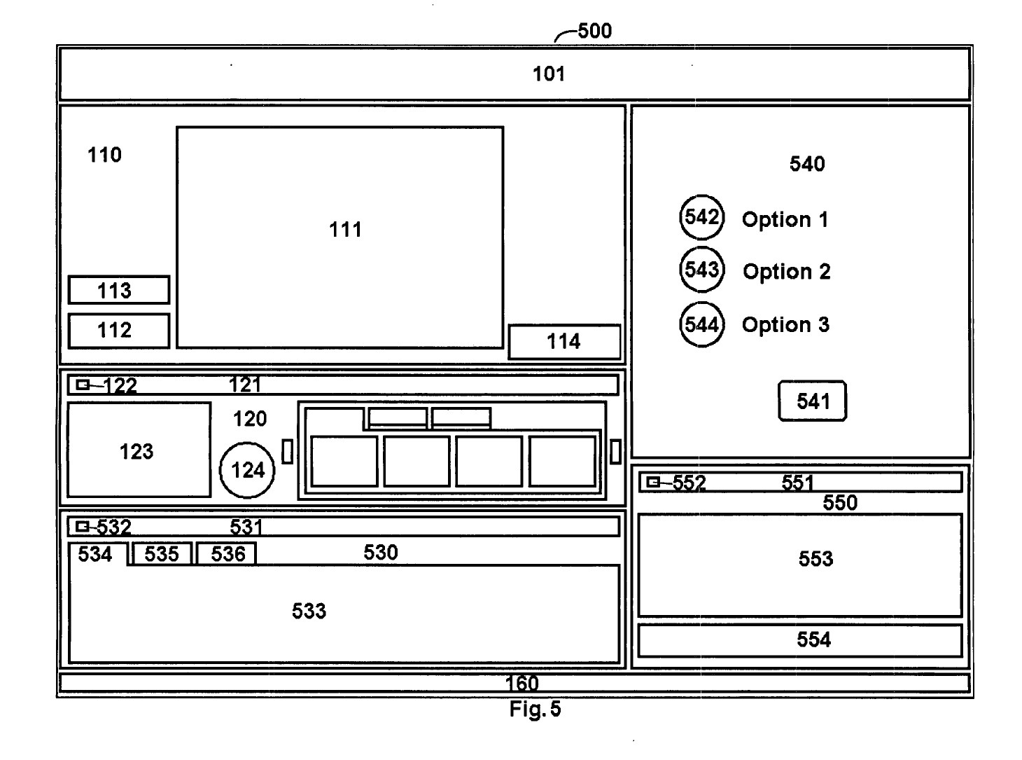

Please refer to FIG. 5, which shows an example layout of a sporting event single page website of the present invention. The page 500 comprises a title area 101, a multimedia pane 110, a scrolling still image control 120, a statistics pane 530, an advertising and polling pane 540, a chatroom pane 550, and a footer 160. The multimedia pane 110 and scrolling still image control 120 are similar to those in the first embodiment above; however, the other panes are used for different purposes. The statistics pane 530 displays statistics for the current sporting event and/or past similar sporting events, such as overall statistics for the event, the teams and, the individual players. The statistics pane 530 comprises a windowshade bar 531, a toggle button 532, a statistics display area 533, and a plurality of tabs 534˜536; the tabs allow the user to select among different groupings of statistics. For example, if the event is a baseball game, the per-inning scores could be shown in one tab, the at-bat player's history in a second, and the team's record in a third. Please note that more or fewer tabs may be used as desired. The advertising and polling pane 540 allows sponsors to display advertising and to generate user interest by asking polling questions of the user, such as the event's most valuable player or the most memorable play; humorous advertiser-specific polls such as “best beer, lite or draft?” are also possible. When displaying a poll, a submit button 541 and a plurality of poll choices 542˜544 are displayed for the user to choose from. The chatroom pane 550 allows fans to discuss the event and other topics among themselves, with the discussion optionally being moderated by the site administrators. The chatroom pane 550 comprises a windowshade bar 551, a toggle button 552, a display area 553, and a user entry area 554.

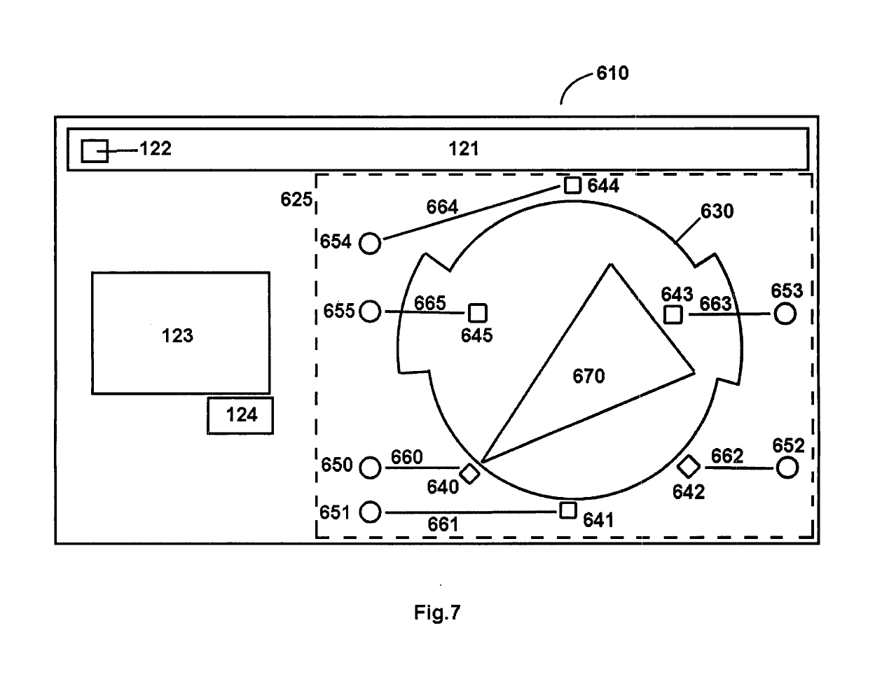

Please refer to FIG. 7, which shows a user selectable multiple camera angle control for a single page website of the present invention. The user selectable multiple camera angle control 610 comprises the windowshade bar 121, the toggle button 122, the preview pane 123, the activation button 124, and a stadium camera layout 625. The stadium camera layout 625 comprises a stadium layout 630, a plurality of marked camera positions 640˜645, a plurality of camera buttons 650˜655, and a plurality of callout lines 660˜665. There is one camera button per camera position, and each camera button has one callout line indicating its corresponding camera position. Mousing over any given camera button or camera position, for example the camera button 650, causes the corresponding viewing field 670 of the corresponding camera position (in this case, camera position 640) to be indicated on the stadium layout 630. Clicking on a camera button 650˜655 causes a preview to display in the preview pane 123. Clicking on the activation button 124 then causes the full presentation to be shown in the display area 111 of the multimedia pane 110.

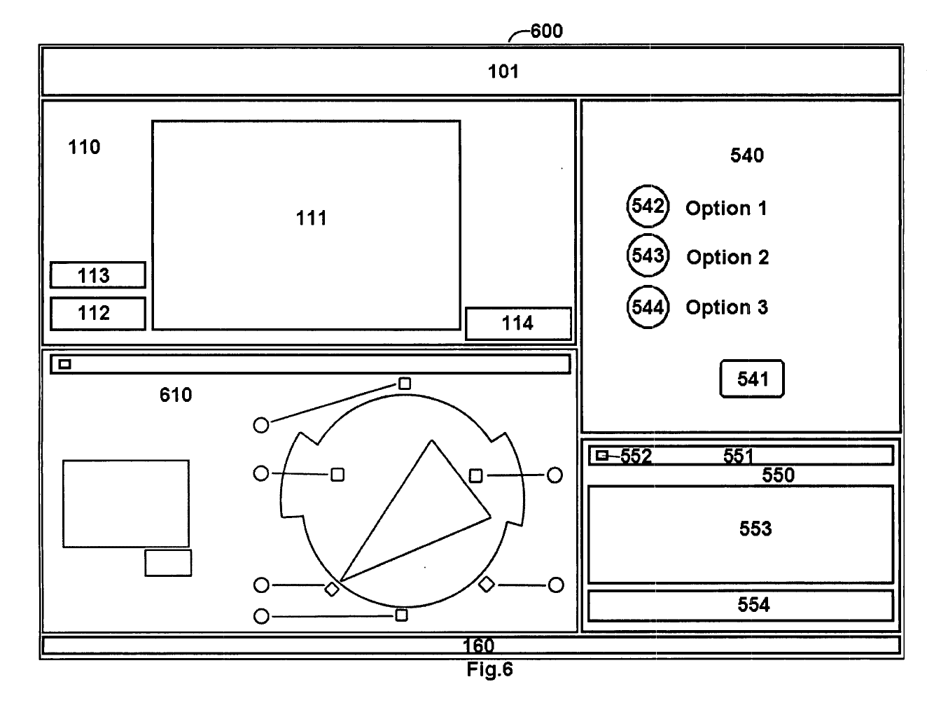

Please refer to FIG. 6, which shows an example layout of a single page website of the present invention. This page 600 is similar to that of FIG. 5, but with the user selectable multiple camera angle control 610 of FIG. 7 in place of both the scrolling still image control 120 and the statistics pane 530.

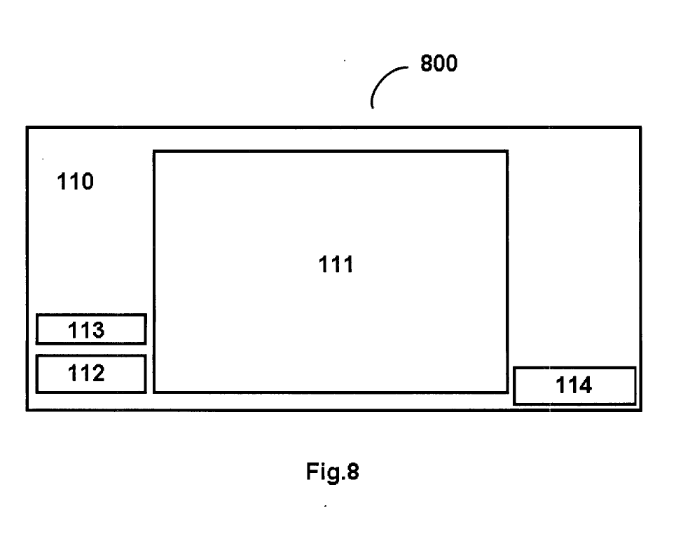

Please refer to FIG. 8, which shows an example layout of a sporting event single page website of the present invention. The page 800 has the multimedia pane 110 maximized to occupy the entire page 800, showing a full view of the selected camera of the event.

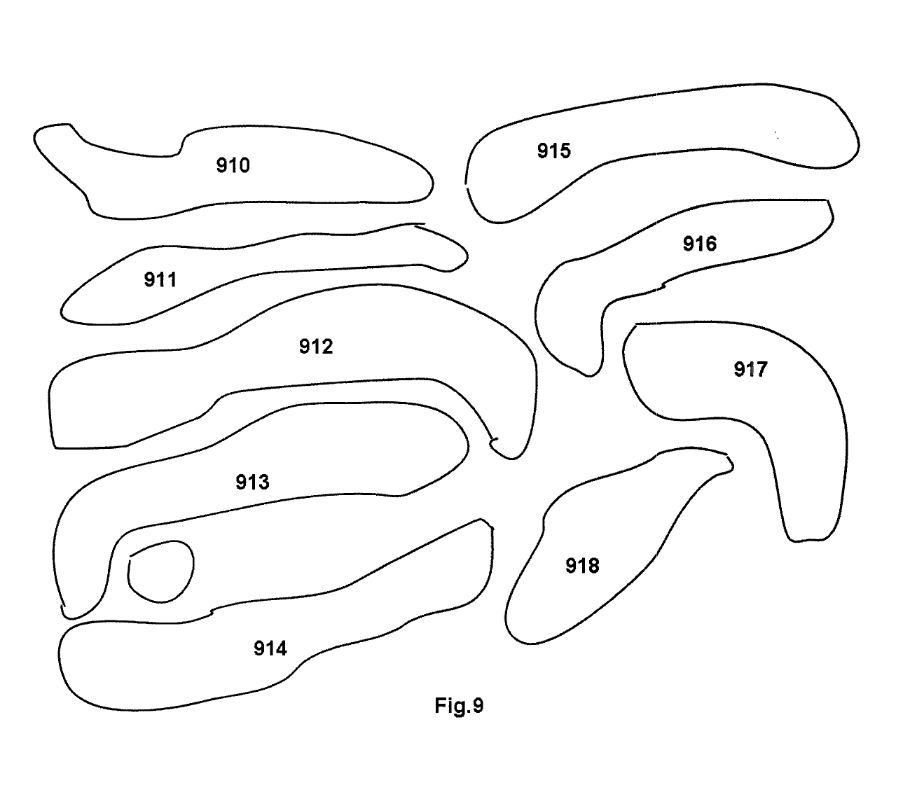

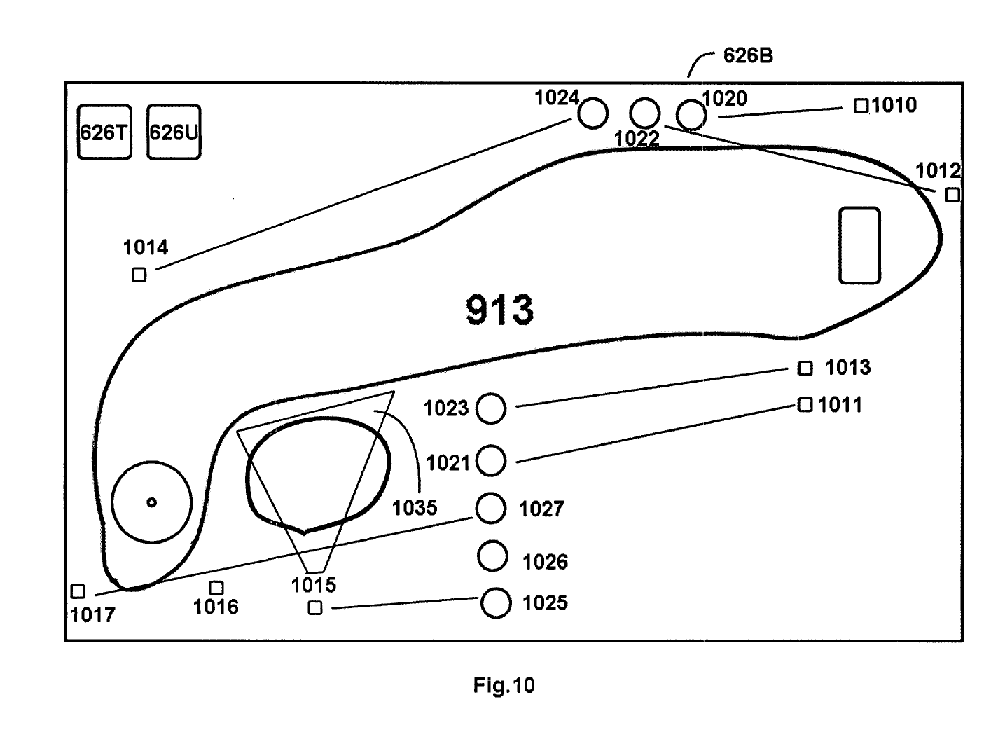

Please refer to FIG. 9 and FIG. 10, which respectively show a first and a second level of a layout for a user selectable multiple camera angle control. The particular sporting event in this embodiment is a golf tournament, and because of the large number of possible cameras, multiple levels are desirable. Although only two levels are shown for the sake of brevity, any number of levels could be implemented. The user selectable multiple camera angle control 610 initially displays the top level layout 626A, which displays an overview of the golf course. Selecting any individual hole 910˜918 brings up a lower level layout 626B displaying the layout for the individual hole 913 and its camera positions 1010˜1017. For example, per hole, a camera or even multiple camera angles at the tee 1010˜1011, a camera displaying a view down the fairway 1012, cameras on each side to view the roughs 1013˜1014, cameras on each individual trap 1015, and at least one camera viewing the green 1016˜1017 can each be selected by the user from the lower level layout. For convenience, camera buttons 1020˜1027 are located in organized rows and callouts indicate the related camera positions 1010˜1017. Mousing over any given camera button or camera position, for example the camera button 1025, causes the corresponding viewing field 1035 of the corresponding camera position (in this case, camera position 1015) to be indicated on the layout 626B. Selecting the up button 626U on any lower level layout 626B returns the control to display the next-higher level layout, in this case the top level layout 626A. On layouts with more than two levels, selecting an optional top button 626T on any lower level layout 626B returns the control to display the top level layout 626A. (Although shown here, in a two level layout, a top button 626T is equivalent to an up button 626U.)

The single page website of the present invention is not restricted solely to product marketing and sporting events. It has uses in a wide variety of applications, such as for group interviews, customer service, market research, market feedback surveys, and video dating. Home surveillance so that a user can monitor his house while away is another useful application. The present invention is not limited geographically to a small area, either; traffic monitoring for a regional road system, livestock monitoring for farmers using either fenced or open-range grazing, commercial pipeline and infrastructure monitoring, and even a “webcams of the world” application in which world-wide webcams are tied together with a global map for tourism interest and promotion, scholarly or educational use, or disaster monitoring and recovery, are all useful wide-ranging applications.

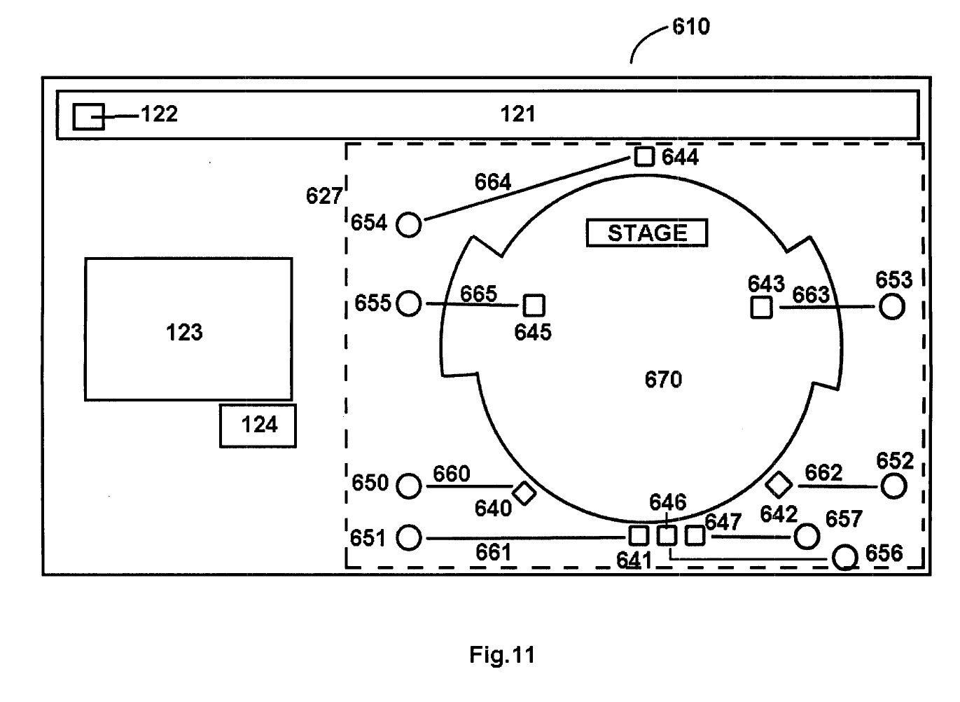

One potentially major application is for concerts. The user selectable multiple camera angle control 610 for such an event comprises a concert layout 627 as shown in FIG. 11. Using a camera button 650˜657, the user can select a camera position 640˜647 showing a broad view of the stage, an individual performer on stage, or a group. Cameras showing multiple perspectives of an individual performer may be desirable in some settings, such as for the lead singer in a rock band. Other selectable cameras show a broad view of the audience. Human-controlled cameras, also selectable, might focus in on individuals in the audience or pan across the crowd.

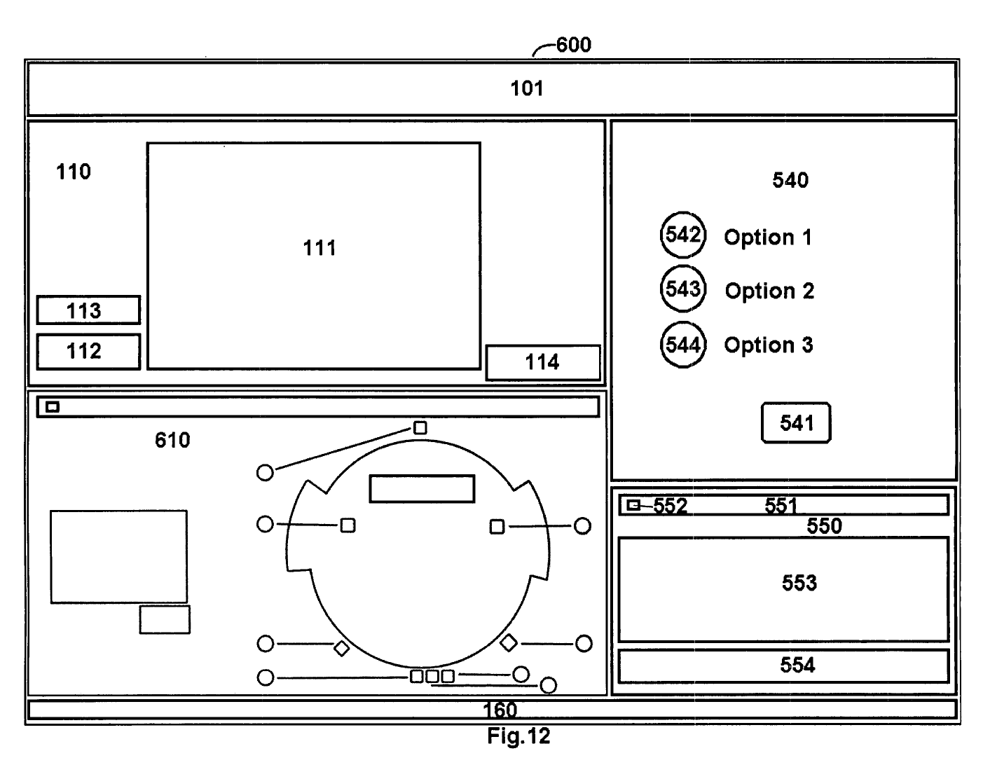

Referring to FIG. 12 in combination with FIG. 11, the advertising and polling pane 540 can be used to advertise merchandising items from the concert tour such as tee shirts and other clothing items, an audio or audio-video recording of the current concert (downloadable or mail-order), and donations and benefit-auction items for charity concerts. Benefit-auction items can be bid upon using the polling mechanism, with credit vetting for larger items performed by checking credit cards. The advertising and polling pane 540 can also be used to advertise and sell past recordings and video items (downloadable or mail-order) for the band. When the user selects a camera showing an individual on stage, the advertising can be targeted on past solo albums or collaborations involving said individual; when the user selects a camera showing the group as a whole, the advertising can focus on the group's past efforts. The chatroom pane 550 allows viewers to interact with each other, discussing the performance and the audience.

In addition to advertiser-sponsored cameras, charging users to view backstage cameras is an option for generating additional revenue: a “backstage pass” for those who would like to watch the concert production and support. Prior to the concert, during intermissions and after the concert, the user selectable multiple camera angle control 610 can switch to display a scrolling still image bar 120 from which prerecorded interviews, past concerts, or other items of possible interest can be selected for viewing. This helps to retain the interest of the user so that more advertising can be shown, potentially generating further sales.

Further revenue can be generated by charging merchants for access to the targeted advertising system, either in part or in whole, if the concert promoter prefers not to handle all of the merchandising and advertising on its own.

In an interviewing or dating application, users' webcam feeds would be selectable with the scrolling still image control, and the chatroom pane would be user-settable to be either a group chat or one-on-one with the currently selected feed, said selected feed being the one displayed in the display area of the multimedia pane. Depending on the application, more or fewer panes may be used, in a variety of different layouts such as horizontal or grid. The single page website of the present invention features multiple functions in a single page, previewing of multimedia, and the use of scrolling controls to fit multiple products into a smaller area over a period of time instead of spreading them over a large space.

The present invention further allows sponsorship of individual cameras. This provides for an effective advertisement sponsored business model where the cost of additional cameras can be offset by sponsored advertising. In this way, when a user selects a specific camera angle, advertising of the sponsor's product or service is displayed in an advertisement pane.

It should be noted that the specific layout can be adapted or altered to meet various requirements.

An advantage of the present invention is that instead of transmitting the data for the entire interface and content, only data for the panes or areas of the interface that need to be updated are sent. In this way, data for static areas of the interface do not need to be continuously re-sent. This greatly improves the speed and quality of the interface.

Additionally, since the present invention provides a single screen interface without the need for scrollbars, user satisfaction is increased and ease of use is improved. As a result, users are more likely to stay, use, and return more frequently.

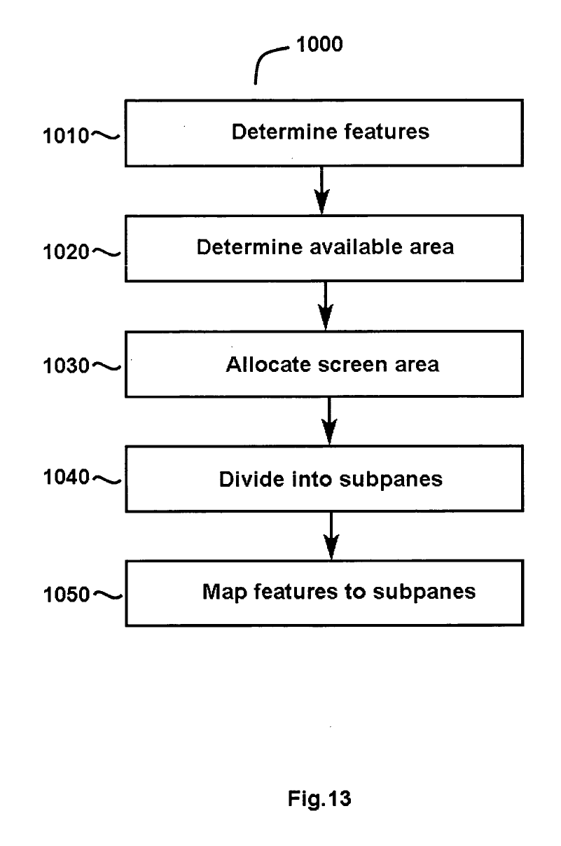

Please refer to FIG. 13, which is a flowchart illustrating the website interface organization method of the present invention. The website organization method 1000 begins with determining the desired features in step 1010. Next, the available display area is determined in step 1020. A screen area is allocated in step 1030. The screen area is divided into a plurality of subpanes in step 1040 such that the subpanes cover the allocated screen area and the number of subpanes is equal to or greater than the number of desired features. Each subpane is assigned, or mapped, to a desired feature of the site in step 1050. It should be noted that ideally no subpanes will be left unused, but this is an option.

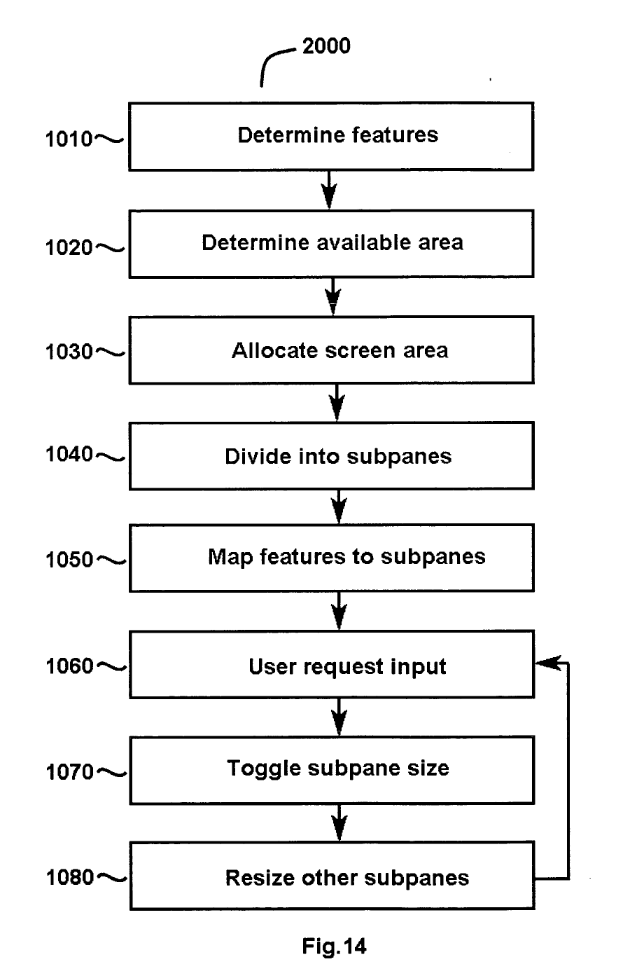

Please refer to FIG. 14, which is a a flowchart illustrating a second embodiment of the website interface organization method of the present invention. The method 2000 encompasses steps 1010˜1050 of method 1000. Once the site has finished being generated in step 1050, the website then operates by awaiting user input. In addition to the typical website activity, the present invention manages website layout such that when the user clicks a windowshade toggle button, the corresponding subpane resizes by toggling from open to closed or from closed to open, depending on its initial state, and the other subpanes are automatically resized by the layout manager as appropriate. In step 1060, the website receives a user resize request for a given subpane. In step 1070, the website resizes the subpane as appropriate to opening or closing. In step 1080, the website layout manager reallocates space for the rest of the subpanes according to its layout policies.

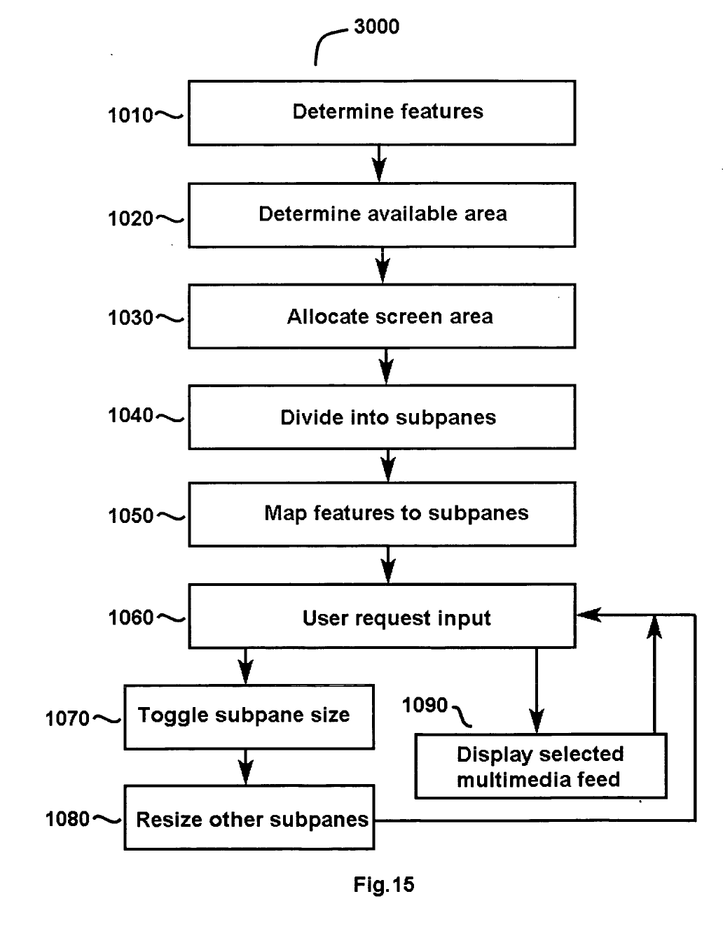

Please refer to FIG. 15, which is a flowchart illustrating a third embodiment of the website interface organization method of the present invention. FIG. 15 extends FIG. 14 by providing a multimedia selection pane and a multimedia pane. The method 3000 encompasses steps 1010˜1050 of method 2000. These are mapped in step 1050 as above. When a user multimedia selection request is received in step 1060, the website proceeds to step 1090 and displays the corresponding multimedia feed in the multimedia pane. The website method then returns to step 1060 to await user input.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. A method of organizing a web site interface, comprising:
determining a plurality of features of the web site interface having a first number;
dividing a screen region into a plurality of subpanes having a second number such that the plurality of subpanes covers the screen region; and
mapping each feature of the plurality of features to a subpane of the plurality of subpanes;
where the second number is equal to or greater than the first number.

2. The method of organizing a web site interface of claim 1 where the second number is equal to the first number.

3. The method of organizing a web site interface of claim 1 further comprising:
determining a screen width and a screen height of a user's screen; and
allocating the screen region such that the screen region has a region width smaller than or equal to the screen width and such that the screen region has a region height smaller than or equal to the screen height.

4. The method of organizing a web site interface of claim 1 further comprising:
receiving a user resize request input to change a size of a subpane of the plurality of subpanes;
changing the size of the subpane of the plurality of subpanes according to the user resize request input; and
adjusting sizes of a subset of subpanes of the plurality of subpanes to cover the screen region according to a layout plan.

5. The method of organizing a web site interface of claim 1 further comprising:
assigning a subpane of the plurality of subpanes as a polling subpane;
displaying a request for optional user input in the polling subpane;
receiving a user input; and
updating the polling subpane with information corresponding to the request for optional user input.

6. The method of organizing a web site interface of claim 1 further comprising:
providing a plurality of multimedia feeds;
assigning a first subpane of the plurality of subpanes as a multimedia selector subpane;
assigning a second subpane of the plurality of subpanes as a multimedia subpane;
accepting a user selection input in the multimedia selector subpane; and
displaying a multimedia feed of the plurality of multimedia feeds in the multimedia subpane according to the user selection input.

7. The method of organizing a web site interface of claim 6 further comprising:
assigning a third subpane of the plurality of subpanes as an advertising subpane;
creating a plurality of sponsors;
assigning each sponsor of the plurality of sponsors to a multimedia feed of the plurality of multimedia feeds; and
displaying an advertisement provided by a sponsor in the advertising subpane when the user selects the multimedia feed assigned to the sponsor.

8. The method of organizing a web site interface of claim 6 further comprising:
showing a plurality of representative images in the multimedia selector subpane, such that each representative image represents a multimedia feed of the plurality of multimedia feeds; and
displaying the multimedia feed represented by the representative image in the multimedia subpane when the user selection input selects a representative image of the plurality of representative images.

9. The method of organizing a web site interface of claim 6 further comprising:
displaying a representative image of a physical layout of the plurality of multimedia feeds;
providing a plurality of hotspots such that each hotspot of the plurality of hotspots is linked to a multimedia feed of the plurality of multimedia feeds;
displaying a representative image related to a multimedia feed when the hotspot linked to the multimedia feed is activated; and
displaying the multimedia feed linked to the hotspot in the multimedia subpane when the user selection input selects either the representative image or the hotspot.

10. A method of organizing a web site interface, comprising:
determining a plurality of features of the web site interface having a first number;
determining a screen width and a screen height of a user's screen;
allocating a screen region such that the screen region has a region width smaller than or equal to the screen width and such that the screen region has a region height smaller than or equal to the screen height;
dividing the screen region into a plurality of subpanes having a second number such that the plurality of subpanes covers the screen region; and
mapping each feature of the plurality of features to a subpane of the plurality of subpanes;
where the second number is equal to the first number.

11. The method of organizing a web site interface of claim 10 further comprising:
receiving a user resize request input to change a size of a subpane of the plurality of subpanes;
changing the size of the subpane of the plurality of subpanes according to the user resize request input; and
adjusting sizes of a subset of subpanes of the plurality of subpanes to cover the screen region according to a layout plan.

12. The method of organizing a web site interface of claim 10 further comprising:
assigning a subpane of the plurality of subpanes as a polling subpane;
displaying a request for optional user input in the polling subpane;
receiving a user input; and
updating the polling subpane with information corresponding to the request for optional user input.

13. The method of organizing a web site interface of claim 10 further comprising:
providing a plurality of multimedia feeds;
assigning a subpane of the plurality of subpanes as a multimedia selector subpane;
assigning a subpane of the plurality of subpanes as a multimedia subpane;
accepting a user selection input in the multimedia selector subpane; and
displaying a multimedia feed of the plurality of multimedia feeds in the multimedia subpane according to the user selection input.

14. The method of organizing a web site interface of claim 13 further comprising:
assigning a subpane of the plurality of subpanes as an advertising subpane;
creating a plurality of sponsors;
assigning each sponsor of the plurality of sponsors to a multimedia feed of the plurality of multimedia feeds; and
displaying an advertisement provided by a sponsor in the advertising subpane when the user selects the multimedia feed assigned to the sponsor.

15. The method of organizing a web site interface of claim 13 further comprising:
showing a plurality of representative images in the multimedia selector subpane, such that each representative image represents a multimedia feed of the plurality of multimedia feeds; and
displaying the multimedia feed represented by the representative image in the multimedia subpane when the user selection input selects a representative image of the plurality of representative images.

16. The method of organizing a web site interface of claim 13 further comprising:
displaying a representative image of a physical layout of the plurality of multimedia feeds;
providing a plurality of hotspots such that each hotspot of the plurality of hotspots is linked to a multimedia feed of the plurality of multimedia feeds;
displaying a representative image related to a multimedia feed when the hotspot linked to the multimedia feed is activated; and
displaying the multimedia feed linked to the hotspot in the multimedia subpane when the user selection input selects either the representative image or the hotspot.

17. A method of organizing a web site interface, comprising:
determining a plurality of features of the web site interface having a first number;
determining a screen width and a screen height of a user's screen;
allocating a screen region such that the screen region has a region width smaller than or equal to the screen width and such that the screen region has a region height smaller than or equal to the screen height;
dividing the screen region into a plurality of subpanes having a second number such that the plurality of subpanes covers the screen region;
mapping each feature of the plurality of features to a subpane of the plurality of subpanes;
providing a plurality of multimedia feeds;
accepting a user selection input in a multimedia selector subpane; and
displaying a multimedia feed of the plurality of multimedia feeds in a multimedia subpane according to the user selection input;
where the second number is equal to the first number, and where a subpane of the plurality of subpanes is the multimedia selector subpane, and where a subpane of the plurality of subpanes is the multimedia subpane.

18. The method of organizing a web site interface of claim 17 further comprising:
assigning a subpane of the plurality of subpanes as an advertising subpane;
creating a plurality of sponsors,
assigning each sponsor of the plurality of sponsors to a multimedia feed of the plurality of multimedia feeds; and
displaying an advertisement provided by a sponsor in the advertising subpane when the user selects the multi-media feed assigned to the sponsor.

19. The method of organizing a web site interface of claim 17 further comprising:
showing a plurality of representative images in the multimedia selector subpane, such that each representative image represents a multimedia feed of the plurality of multimedia feeds; and
displaying the multimedia feed represented by the representative image in the multimedia subpane when the user selection input selects a representative image of the plurality of representative images.

20. The method of organizing a web site interface of claim 17 further comprising:
displaying a representative image of a physical layout of the plurality of multimedia feeds;
providing a plurality of hotspots such that each hotspot of the plurality of hotspots is linked to a multimedia feed of the plurality of multimedia feeds;
displaying a representative image related to a multimedia feed when the hotspot linked to the multimedia feed is activated; and
displaying the multimedia feed linked to the hotspot in the multimedia subpane when the user selection input selects either the representative image or the hotspot.
